(19) United States
(12) Patent Application Publication
(10) Pub. No.: US 2004/0024972 A1
(43) Pub. Date: Feb. 5, 2004

(54) Predicting useless accesses

(76) Inventors: Sangwook Kim, Austin, TX (US); Dhananjay Adhikari, Austin, TX (US); Zhong-Ning Cai, Lake Oswego, OR (US)

Correspondence Address: Lester J. Vincent, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/211,679

(22) Filed: Aug. 2, 2002

(51) Int. Cl. G06F 12/00

(52) U.S. Cl. 711/137

(57) ABSTRACT

A predictor of consecutive useless accesses, wherein consecutive useless accesses to a logic unit are counted and a next useless access is predicted to be within a plurality of ranges. Each of the plurality of ranges has a corresponding confidence predictor to track and provide a confidence level of whether a next access to the logic unit will be useless.

### FIELD

Embodiments of the invention relate to the field of power management within a computer system. More particularly, embodiments of the invention relate to improving power management by predicting consecutive useless accesses to one or more circuits within a microprocessor or computer system.

### BACKGROUND

Power consumption is a concern in high-performance microprocessors. Generally, high-performance microprocessors include various logic units, such as predictor circuits and cache memories. Some logic units are enabled and/or accessed in order to improve microprocessor and/or system performance. When logic units produce results that are not desired or used by the microprocessor or system, power can be consumed unnecessarily.

One prior art technique for reducing power consumption is to disable logic units if they do not yield useful results after a number of consecutive access cycles. Other techniques attempt to predict periods during which a logic unit can be disabled without incurring a substantial degradation in system performance. For example, prediction techniques may be implemented for a frequently-accessed level-one (L1) cache memory consisting of two simultaneously accessed, parallel data caches. Parallel data caches may be used in a computer system to achieve higher performance than would be achieved using a single data cache. Parallel caches consume unnecessary power, however, when they are accessed simultaneously because only one will typically contain the requested data or other result.

A prior art technique for predicting useless accesses to a logic unit, such as a cache memory, is illustrated in FIG. 1. The prediction technique illustrated in FIG. 1 counts a consecutive number of useless accesses to a logic unit and disables the logic unit when a threshold number of useless accesses is detected. Because the technique of FIG. 1 uses a single static threshold value to predict when the logic unit should be disabled, however, the power savings can be somewhat limited. Performance may also be degraded due to the time required to enable the logic unit when there is a mis-prediction.

### BRIEF DESCRIPTION OF THE DRAWINGS

Embodiments and the invention are illustrated by way of example and not limitation in the figures of the accompanying drawings, in which like references indicate similar elements, and in which:

FIG. 1 illustrates a prior art prediction technique for useless access.

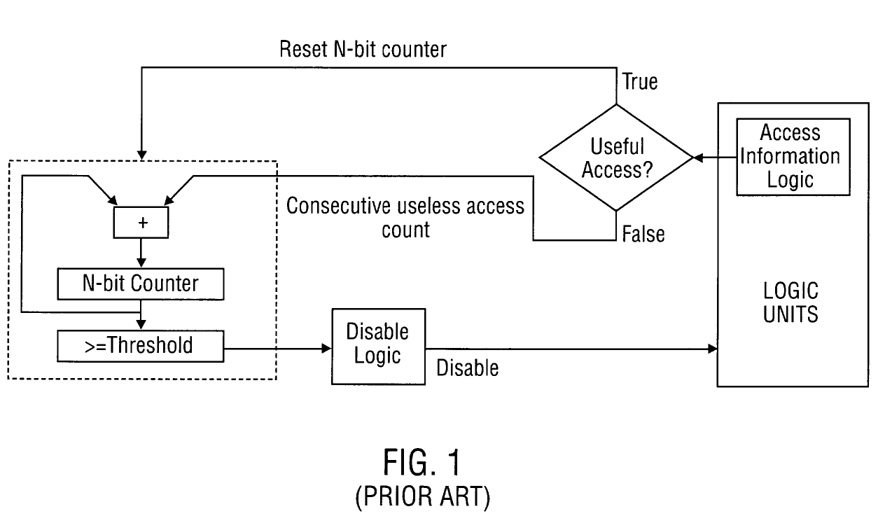

FIG. 2 illustrates a computer system that may be used in conjunction with one embodiment of the invention.

FIG. 3 illustrates parallel cache memories that may be used in conjunction with one embodiment of the invention.

FIG. 4 illustrates a prediction technique for useless access according to one embodiment of the invention.

FIG. 5 illustrates a variable confidence level prediction technique according to one embodiment of the invention.

FIG. 6 is a flow chart of a method of predicting useless access.

### DETAILED DESCRIPTION

Embodiments of the invention described herein pertain to decreasing microprocessor or computer system power consumption without significantly degrading microprocessor and/or computer system performance. More particularly, embodiments of the invention pertain to predicting a useless access to one or more logic units within a microprocessor or computer system and disabling one or more of the logic units if the prediction is made with a high confidence level.

A useless access can mean various things, depending on the function to be performed by the logic unit being accessed. For example, for one embodiment of the invention, the logic unit is a cache memory and the access is considered to be useless whenever it results in a cache miss. In general, however, a useless access is an access to one or more logic units, either within a microprocessor or not, that does not produce or yield, or cause to be produced or yielded, a result that can be used by the microprocessor or computer system, or is not a desired result.

A logic unit can be a hardware circuit, software program, or some combination thereof that performs a function or functions when accessed or otherwise signaled to do so. For example, for one embodiment of the invention, a logic unit is a cache memory that returns data to a requesting agent when a location within the cache memory is read. For other embodiments, a logic unit comprises other devices, circuits, or software.

In order to decrease power consumption within a microprocessor or computer system without significantly degrading performance of the microprocessor or computer system, a prediction technique may be used to predict an access to a logic unit that is likely to produce a useless result. Furthermore, power consumption and performance can be optimized to the extent that the prediction is accurate. Therefore, it is important to predict useless accesses as accurately as possible.

Furthermore, instructions executed within a computer system can propogate through a processor either through a critical path or not. In some cases, whether the instruction is a useless one cannot be accurately known until the instruction causes an access to be made to a logic unit. One embodiment of the invention counts, predicts, and otherwise tracks useless accesses from a logic unit's point of view rather than from a point of view of an instruction. Because the determination of whether an access caused by an instruction is useless is determined when the access is actually made, accesses to a logic unit can be either on-path or off-path instructions.

Embodiments of the invention can be used to improve accuracy of a predicted useless access by counting the number of consecutive useless accesses and predicting whether the next access will also be useless based upon historic patterns of useless or non-useless accesses to a logic unit.

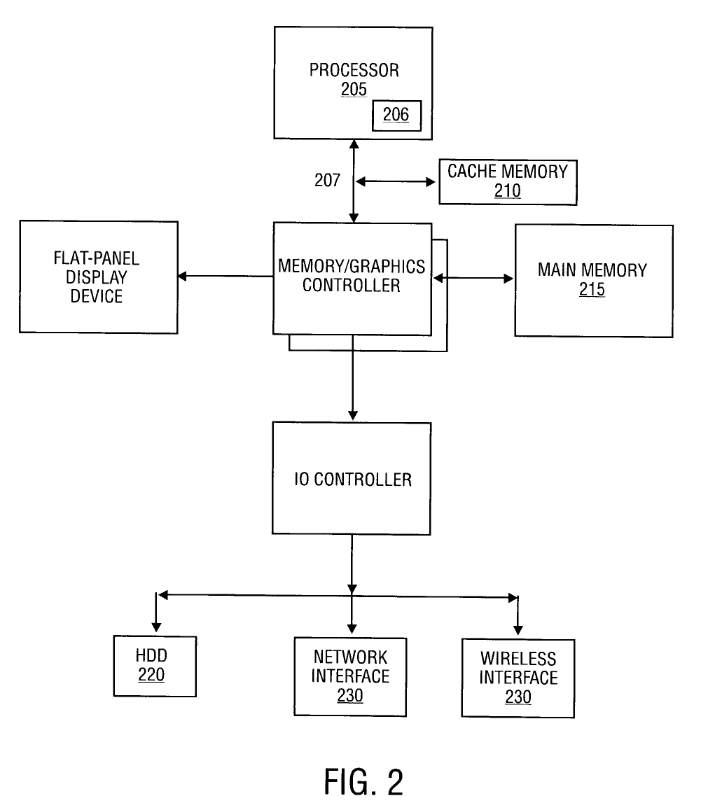

FIG. 2 illustrates a computer system that may be used in conjunction with at least one embodiment of the invention. A processor 205 accesses data from a cache memory 210 and main memory 215. For one embodiment, predictor 206 of useless access is located within processor 205. Embodiments of the invention may however, be implemented within other devices within the system, as a separate bus agent, or distributed throughout the system. For example, for an alternative embodiment, the predictor of useless accesses can reside within cache unit 207 residing on the host bus 208.

The main memory may be dynamic random-access memory (DRAM), a hard disk drive (HDD) 220, or a memory source 230 located remotely from the computer system containing various storage devices and technologies. The cache memory may be located either within the processor or in close proximity to the processor, such as on the processor's local bus 207. Furthermore, the cache memory may be composed of relatively fast memory cells, such as six-transistor (6T) cells, or other memory cells of approximately equal or faster access speed.

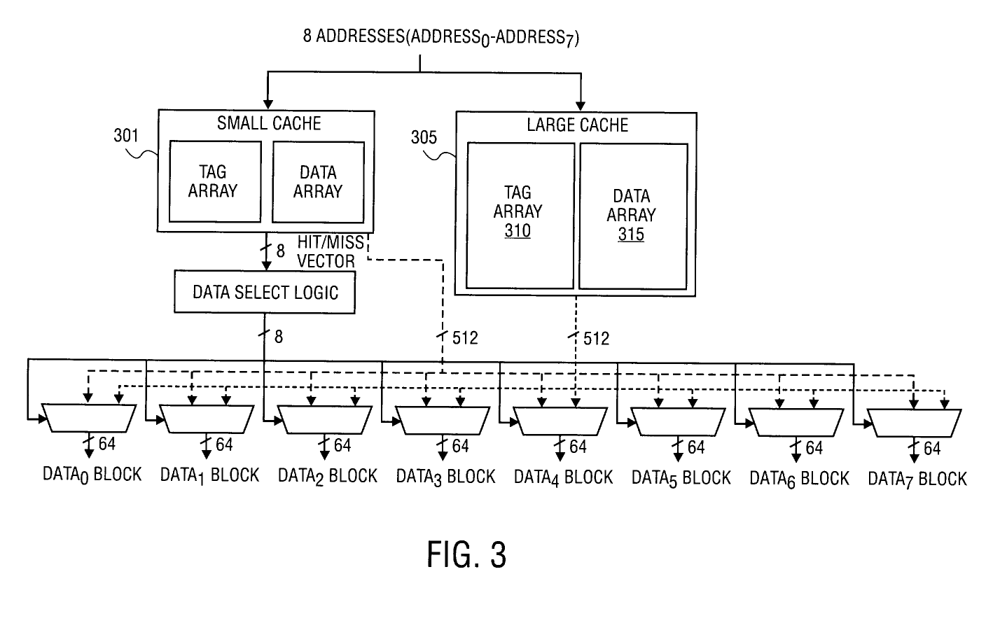

FIG. 3 illustrates parallel cache memories that may be used in conjunction with at least one embodiment of the invention. The parallel cache memories 300 of FIG. 3 comprise a small data cache 301 and a large data cache 305. Large and small data caches may be used in a computer system or microprocessor in order optimize the time it takes to access cached data. The large cache can store more data, but may require more time to access the data due to the amount of decoding necessary to search through the tag array 310 and access the data in the large data array 315. Data can be accessed faster from the small cache, but the small cache cannot store as much data as the large cache.

In order to optimize performance, both caches may remain enabled and, therefore, accessed in parallel. Only one cache will typically store the requested data (if at all), however, resulting in a cache miss in one of the caches and wasted power consumption.

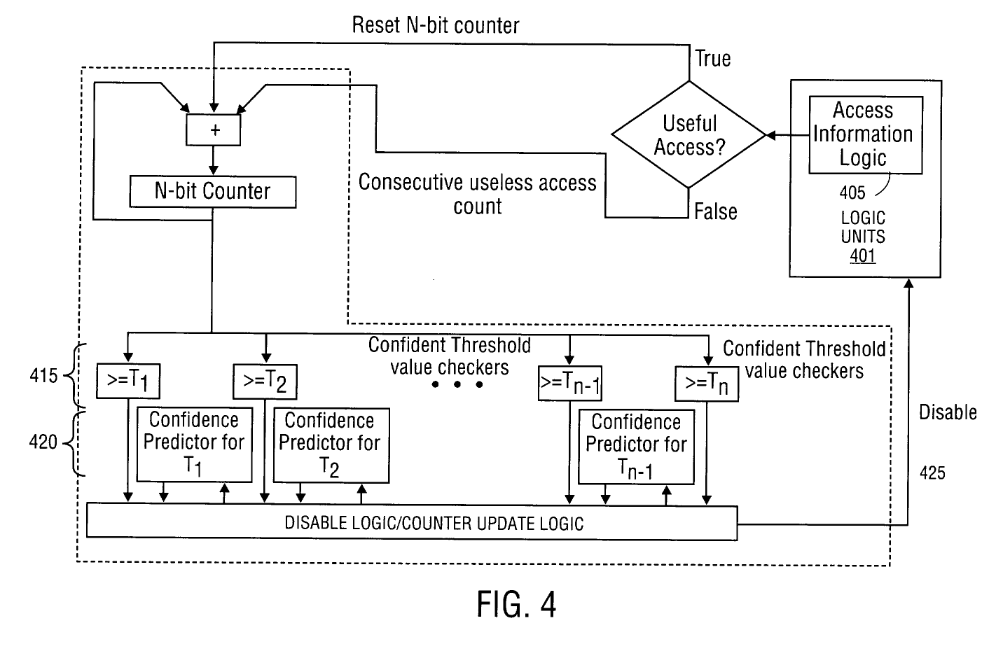

FIG. 4 illustrates a useless access prediction technique according to one embodiment of the invention. A logic unit 401 is accessed by a requesting agent, such as a microprocessor. An access information unit 405 provides information as to whether the access is useful. For example, if the logic unit is a cache memory, the access information unit would detect whether the access was a cache hit or cache miss. Other logic units may require that the access information unit detect other information in order to determine whether an access is useless.

If the access is useless, a counter 410 is incremented, and if it is not useless, the counter is reset to zero. The counter value is compared to one or more threshold values 415 in order to determine the number of consecutive useless accesses that have taken place. Any number of threshold values may be compared to the counter value, but the more threshold values that are compared, the more accurate a prediction that can be made.

The set of threshold values, Ti (1<=i<=n) are used to help predict consecutive useless accesses. Each threshold value (except the last Tₙ) is associated with a confidence level predictor. For the embodiment illustrated in FIG. 4, the confidence level predictor is implemented with a 2 or 3-bit counter-based predictor 420 to track and provide a confidence level of the detected threshold range. Other techniques may be used to track and provide a confidence level of a useless access prediction in other embodiments, such as a state machine or table. By maintaining the confidence level for each detected threshold range, a useless access prediction can be made that is based off of historical useless access patterns.

For example, if the comparators detect that the reset counter value is between the interval T1 and T2 (denoted as (T1, T2)), the confidence predictor for T1 is checked. If the confidence level is high, the corresponding logic unit (or units) is (are) disabled. Advantageously, this technique enables useless access predictions to adapt to logic unit access patterns. In the embodiment illustrated in FIG. 4, the disable signal 425 will be generated if the reset counter value reaches Tn (the absolute threshold value) regardless of any confidence level predictor. Therefore, when no useful access to the logic units occur for a long period of time, the predictor will disable the logic unit or units.

The threshold values and confidence levels upon which a useless access prediction is based may vary among embodiments of the invention, depending upon considerations, such as cost, power, and performance. In general, the confidence predictors are updated such that when a logic unit is disabled, they indicate whether the power savings realized by disabling the logic unit is large enough to justify the performance cost in re-enabling the logic unit when it is needed.

The confidence predictor level associated with threshold Ti is incremented after a useful access occurs and the counter has a consecutive useless access value greater than or equal to Ti+1. The confidence predictor is decremented when a useful access occurs and the value is greater than or equal to Ti but less than Ti+1. Hence, the confidence of a useless access prediction associated with interval [Ti, Ti+1) is reinforced when no useful access occurs in that interval. On the other hand, the confidence of a useless access prediction associated with interval [Ti, Ti+1) is weakened when a useful access occurs in that interval.

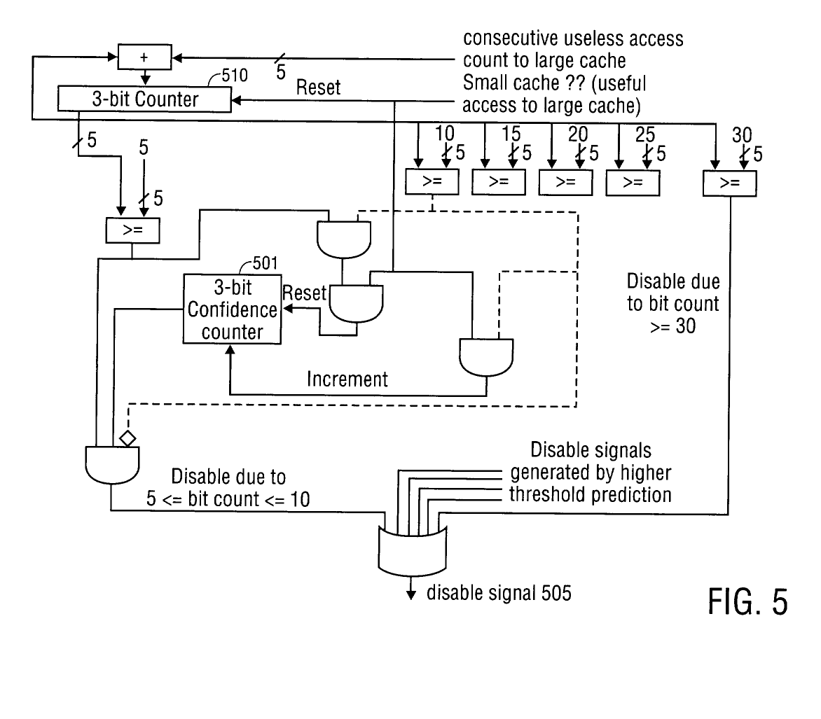

FIG. 5 illustrates a variable confidence level prediction technique according to one embodiment of the invention. A 2-bit counter 501 is used to track and provide a confidence level of whether a useless access will occur consecutively within a range of consecutive useless accesses, [Ti, Ti+1). The 2 bit counter is incremented when the 5-bit consecutive useless access counter 510 increments and contains a value in the range [Ti, Ti+1). However, the 2-bit counter is reset to zero if a useful access occurs when the 5-bit counter contains a value in the range [Ti, Ti+1).

A disable signal 505 is generated to disable the corresponding logic unit if the 5-bit counter value is in the range [Ti, Ti+1) and the confidence level predictor is at a value that is deemed to be high. The value of the 2-bit counter that is considered to represent a high confidence level can change with different embodiments. For the embodiment illustrated in FIG. 5, a high confidence level is considered to be a value of 3 or above, as represented by the 2-bit counter. Furthermore, the 5-bit and/or 2-bit counters may be implemented with other circuits, software, or some combination thereof, including counters of different ranges than those illustrated in FIG. 5.

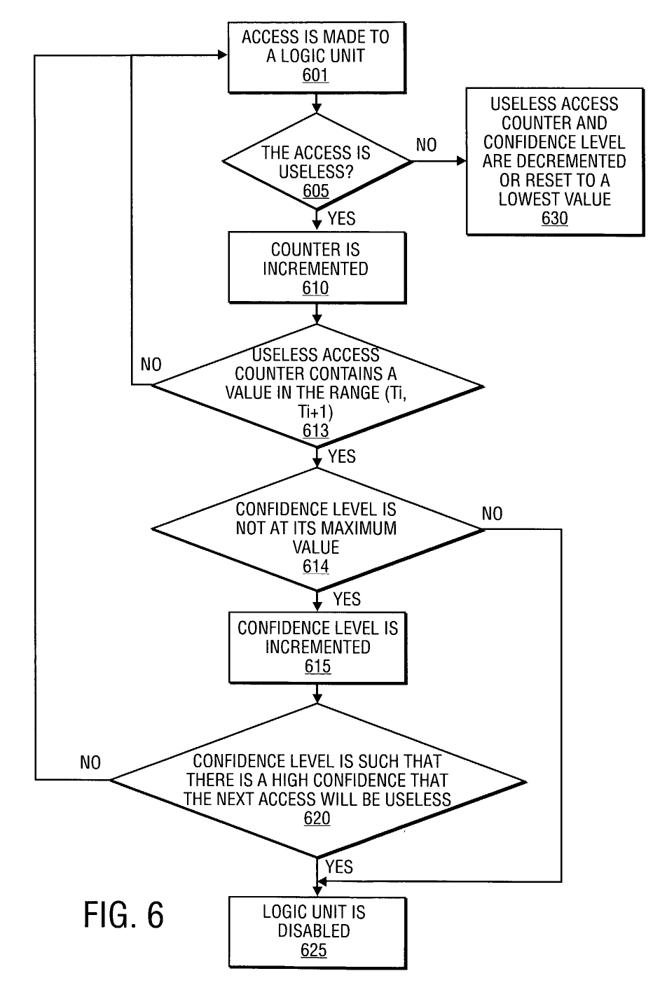

FIG. 6 is a flow chart illustrating the prediction of useless access. An access is made to a logic unit 601, and it is determined whether the access is useless 605. If the access is useless, a useless access counter is incremented 610. The the useless access counter is checked to see if it contains a value in the range [Ti, Ti+1) 613. If so, and the confidence level is not at its maximum value 614, the confidence level is incremented 615. If the confidence level is at its maximum, it remains the same. Next, it is determined whether the confidence level is such that there is a high confidence that the next access will be useless 620. If so, the logic unit is disabled 625. If an access to the logic unit is useful, the useless access counter and confidence level are decremented or reset to a lowest value 630.

Embodiments of the invention may include various implementations, including circuits (hardware) using complementary metal-oxide-semiconductor (CMOS) technology, machine-readable media with instructions (software) to perform embodiments of the invention when executed by a machine, such as a processor, or a combination of hardware and software.

While the invention has been described with reference to illustrative embodiments, this description is not intended to be construed in a limiting sense. Various modifications of the illustrative embodiments, as well as other embodiments, which are apparent to persons skilled in the art to which the invention pertains are deemed to lie within the spirit and scope of the invention.

What is claimed is:

1. An apparatus comprising:
a first unit to perform at least one function within a computer system;
a second unit to make a prediction of whether an access to the first unit will yield a desired result;
a third unit to determine a confidence level of the prediction;
a fourth unit to disable the first unit if the second unit predicts that the access to the first unit will not yield a desired result and the third unit determines that the confidence level of the prediction is equal to or greater than a predetermined value.

2. The apparatus of claim 1 wherein the confidence level is incremented if at least a threshold number of consecutive accesses are made to the first unit that do not yield a desired result followed by an access to the first unit that does yield a desired result.

3. The apparatus of claim 1 wherein the confidence level is incremented if a first number of consecutive accesses to the first unit that do not yield a desired result is greater than a first threshold value and less than a second threshold value.

4. The apparatus of claim 3 further comprising a counter to count the first number of consecutive accesses to the first unit that do not yield a desired result.

5. The apparatus of claim 1 further comprising a plurality of comparators to compare a plurality of consecutive accesses that do not yield a desired result to a plurality of threshold values.

6. The apparatus of claim 5 wherein the first unit is one of a plurality of units that can be accessed in parallel to yield a desired result.

7. The apparatus of claim 6 wherein the plurality of units are cache memories.

8. The apparatus of claim 6 wherein each of the plurality of units comprises access information logic to indicate whether an access to the plurality of units yields a desired result.

9. A system comprising:
a cache memory;
a bus agent to access the cache memory;
a useless access prediction unit to predict whether an access to the cache memory will yield a desired result, the useless access prediction unit comprising a plurality of comparitors to compare a number of consecutive useless accesses to the cache memory to a plurality of threshold values, the useless access prediction unit further comprising a plurality of state machines to provide a confidence level of whether the number of consecutive useless accesses is between a first and second threshold value.

10. The system of claim 9 wherein a state of at least one of the plurality of state machines is changed if the number of consecutive useless accesses is between the first and second threshold value.

11. The system of claim 10 further comprising a disable unit to disable the cache memory if the useless access prediction unit strongly predicts that a next access to the cache memory will be not yield a desired result.

12. The system of claim 11 wherein the cache memory is one of a plurality of cache memories comprising at least two cache memories able to be accessed in parallel.

13. The system of claim 12 wherein the at least two cache memories are different sizes.

14. The system of claim 12 wherein the at least two cache memories have different access speeds.

15. The system of claim 13 wherein the at least two cache memories comprise access detection logic to indicate to the useless access predictor whether the cache contains a desired data.

16. The system of claim 9 wherein the useless access prediction unit comprises a counter to count a number of consecutive useless accesses, the counter being able to be reset after the cache memory returns a desired result.

17. The system of claim 16 wherein the bus agent is a microprocessor, the microprocessor comprising the useless access prediction unit.

18. An apparatus comprising:
means for counting a number of useless consecutive accesses to at least one of a plurality of parallel logic units;
means for comparing the number of useless consecutive accesses with a plurality of threshold values;
means for predicting whether a next access to at least one of the plurality of logic units will be useless;
means for disabling the at least one of the plurality of logic units if the means for predicting predicts that the next access will be useless.

19. The apparatus of claim 18 further comprising means for generating a confidence level of a prediction made by the means for predicting.

20. The apparatus of claim 19 wherein the means for counting is reset after a non-useless access is made to one of the plurality of parallel logic units.

21. The apparatus of claim 19 wherein the means for generating a confidence level increments a confidence level after a number of consecutive useless accesses is equal to or greater than a first threshold level and less than a second threshold level.

22. The apparatus of claim 21 wherein the means for generating a confidence level comprises a 2-bit counter.

23. The apparatus of claim 21 wherein the means for counting comprises an 8-bit counter.

24. The apparatus of claim 21 wherein the means for comparing comprises a plurality of comparitors.

25. The apparatus of claim 21 wherein the means for predicting comprises a plurality of comparitors and a plurality of means for generating a means for generating a confidence level.

26. The apparatus of claim 18 wherein the plurality of parallel logic units comprises two cache memories of different sizes.

27. A method comprising:
accessing a first cache memory;
counting a first consecutive number of cache misses to the first cache memory;
comparing the first consecutive number of cache misses to a first and second threshold value;
predicting that an access to the first cache memory subsequent to the first consecutive number of cache misses will be a miss if the first consecutive number of cache misses is less than the second threshold value and greater or equal to the first threshold value and a prediction confidence is equal to or greater than a first confidence level.

28. The method of claim 27 wherein the prediction confidence is increased if a cache hit occurs and the first number of consecutive cache misses is greater than or equal to the second threshold value.

29. The method of claim 27 wherein the prediction confidence is decreased if a cache hit occurs and the first number of consecutive cache misses is greater than or equal to the first threshold value but less than the second threshold value.

30. The method of claim 28 further comprising disabling the first cache memory if the access to the first cache memory subsequent to the first consecutive number of cache misses is predicted to be a cache miss.

31. The method of claim 30 wherein the counting begins from zero after a cache hit occurs.

32. The method of claim 27 further comprising accessing at least one cache memory in parallel with the first cache memory.

33. The method of claim 28 wherein the prediction confidence is increased by incrementing a counter.

34. The method of claim 29 wherein the prediction confidence is decreased by reseting a counter.

35. A machine-readable medium having stored thereon a set of instructions, which when executed by a machine cause the machine to perform a method comprising:
monitoring an access of a plurality of logic units;
conserving power in a computer system by predicting a consecutive useless access to at least one logic unit of the plurality of logic units and subsequently disabling the logic unit, the predicting being dependent upon a previous number of useless consecutive accesses to the logic unit, the previous number being greater than or equal to a first threshold value and less than a second threshold value.

36. The machine-readable medium of claim 35 wherein the monitoring comprises incrementing a counter after each of the previous number of useless consecutive accesses.

37. The machine-readable medium of claim 35 further comprising adjusting a confidence level in a prediction of the consecutive useless access to the at least one logic unit.

38. The machine-readable medium of claim 37 wherein the confidence level is adjusted according to a number of times a next access to the at least one logic unit after the previous number of consecutive useless accesses is a non-useless access.

39. The machine-readable medium of claim 38 wherein the confidence level is increased by incrementing a confidence counter.

40. The machine-readable medium of claim 39 wherein the access to the plurality of logic units occurs in parallel.

41. The machine-readable medium of claim 40 further comprising determining whether the predicting is accurate.

42. The machine-readable medium of claim 41 further comprising decreasing the confidence level if the predicting is innacurate, the decreasing being performed by decrementing the confidence counter.

43. The machine-readable medium of claim 42 wherein the plurality of logic units are cache memories.
